(19) United States
(12) Patent Application Publication
(10) Pub. No.: US 2005/0074738 A1
(43) Pub. Date: Apr. 7, 2005

(54) Documentation-based teacher qualification rating system and method

(76) Inventors: John Garrett Tomlinson, Greensboro, NC (US); Debra Smathers Martin, Swannanoa, NC (US)

Correspondence Address: INTELLECTUAL VENTURES, LLC, 1756 - 114TH AVE., S.E., SUITE 110, BELLEVUE, WA, 98004, US

(21) Appl. No.: 10/816,157

(22) Filed: Apr. 1, 2004

Related U.S. Application Data
(63) Continuation-in-part of application No. 10/679,735, filed on Oct. 6, 2003.

(51) Int. Cl. G09B 25/00

(52) U.S. Cl. 434/365

(57) ABSTRACT

A documentation-based teacher qualification rating system and method, wherein the system and method provide for documentation input by the teacher to satisfy a matrix of factors; each factor being weighted and the inputs being assigned points based on their weighting; the points then being summed to arrive at the overall rating. Also, an automated system further including remote inputting of documentation via electronic network and semi-automated assessment.

### CROSS-REFERENCE TO RELATED APPLICATIONS

This nonprovisional utility patent application claims the benefit of one or more prior filed co-pending nonprovisional applications: the present application is a Continuation-In-Part of application Ser. No. 10/679,735, which is incorporated herein by reference in its entirety.

### BACKGROUND OF THE INVENTION

(1) Field of the Invention

The present invention relates generally to human resources management and, more particularly, to management of participants within a teacher staffing program.

(2) Description of the Prior Art

The federal “No Child Left Behind” (NCLB) Act requires that all teachers of core subjects demonstrate that they are “highly qualified” in the teaching of their subject matter. Normally, US teachers take a qualification test to achieve this “highly qualified” rating. Currently, all teachers of core subjects in federally funded Title I schools and, by Jun. 30, 2006, teachers of core subjects in all schools must be designated “highly qualified” before they begin instruction. For international teachers coming into the United States of America on a cultural exchange visa, it is logistically impossible for them to take a qualification exam or demonstrate qualification in any other manner.

The NCLB Act provides an alternative method to demonstrate subject area competency to be designated as “highly qualified”. This method is known as the High Objective Uniform State Standard of Evaluation (HOUSSE).

When testing is not an option, the present invention fulfills the need for an alternative teacher evaluation method by providing an automated rating system for evaluating teachers as being “highly qualified” based on evidence.

### SUMMARY OF THE INVENTION

The present invention is directed toward a system and method for rating documentation for teacher qualification.

In a preferred embodiment, the system and method according to the present invention are automated within the context of a network of computers, such as a local area network or a wide area network like the Internet or World Wide Web.

Accordingly, one aspect of the present invention is to provide a system for rating teachers based on a matrix of factors consisting of teacher documentation.

Another aspect of the present invention is to provide a method for operating a rating system for teachers comprising the steps of: providing a rating system based on a matrix of factors with factor weighting, inputting factor documentation, determining the individual factor and total factor points based on the inputted factor documentation, and determining the teacher qualification rating based on the total factor points.

Still another aspect of the present invention is to provide an automated system and method according to the present invention as set forth herein for permitting remote access to the program information and/or administration thereof by the participants via a network of computers.

These and other aspects of the present invention will become apparent to those skilled in the art after a reading of the following description of the preferred embodiment when considered with the drawings.

### BRIEF DESCRIPTION OF THE DRAWINGS

FIG. 1 is a flow chart of a documentation-based teacher qualification rating method according to the present invention.

FIG. 2 is a schematic diagram of a network-based system according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

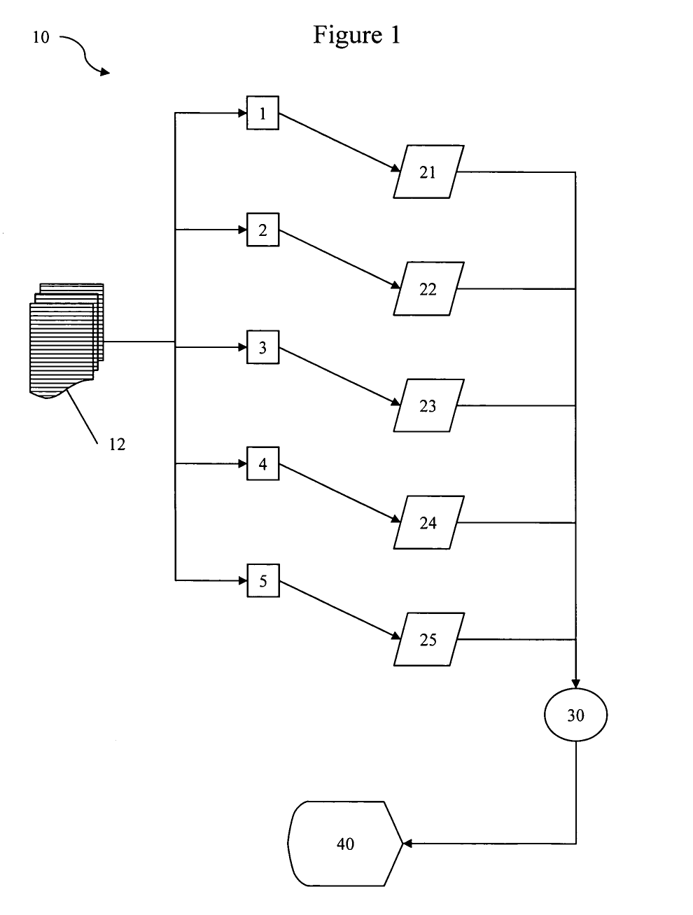

Referring now to the drawings in general, the illustrations are for the purpose of describing a preferred embodiment of the invention and are not intended to limit the invention thereto. As best seen in FIG. 1, a method according to the present invention, generally referenced as 10, includes the steps of providing a rating system based on a matrix of factors 1 through 5 with factor weighting; inputting factor documentation 12; determining the individual factor points (21 through 25) and total factor points 30 based on the inputted factor documentation; and determining the teacher qualification rating 40 based on the total factor points.

The inputted documentation is addressed to an individual factor/standard. In the example shown in FIG. 1, five factors/standards are used: Core Content Knowledge in Academic Subject 1; Grade Appropriate Knowledge of Subject Matter 2; Grade Appropriate Academic Subject Matter Teaching Skills 3; Differentiation of Content Instruction for Diverse Learners 4; and Student Assessment and Achievement of Core Content Concepts 5.

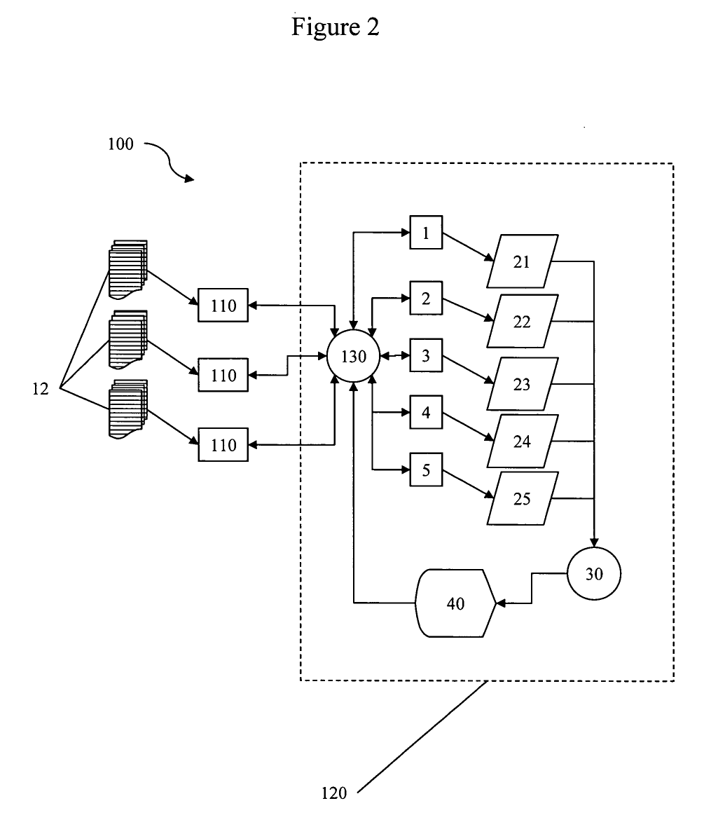

The present invention also preferably includes an automated system and method for rating teachers. In a preferred embodiment, the present invention is an Internet-based or other network-based self-administered teacher rating system that receives documentation inputted by a teacher and rates the qualification of the teacher via an agency-administered rating system based on the inputted documentation. Shown in FIG. 2 is a schematic of a computer network, generally described as 100, for receiving documentation inputs and rating teacher qualification based on the inputted documentation. In this example embodiment, client computers 110 are networked to a server 120. Participating users input documentation 12 addressed to a particular factor. The server processor 130 receives the documentation and applies it toward a particular factor (1 through 5) for processing. The processing determines the individual factor points (21 through 25) and total factor points 30 based on the inputted factor documentation, then determines the teacher qualification rating 40 based on the total factor points. The teacher qualification rating is then communicated to the appropriate network clients 110.

The present invention applies a teacher's portfolio of evidence against standards as a substitute for a qualification test. In the present invention, teachers are those persons who teach elementary, middle, and high school students, wherein each teacher has respective experience/expertise in at least one subject matter or interdisciplinary subject matter relevant to those students.

The present invention replaces testing with a set of evidence that meets the HOUSSE standards in the state in which it is applied. The present system and method according to the present invention include a process that divides the standards into a number of categories. A collection of documentation is assembled and applied against the standards, with weighting of the documentation based on importance.

The present invention rates the respective experience/expertise of each teacher based on teacher-inputted documentation of experience/expertise. The inputted documentation includes objective documents, subjective documents, and other types of documents.

Objective documents include education-related documents and work history-related documents. Education-related documents include diplomas, certificates, transcripts, and other coursework-related documents, such as thesis and licensure, and the like. Work history-related documents include professional reference forms/letters, verification of experience, and professional development, and the like.

Subjective documents include teacher essays, lesson plans/unit plans, in-person interviews, teacher demonstrations, classroom observations, telephonic interview summaries, and the like.

Other documents may also be used, such as a subject area/professional test taken in the home country or subject area teaching awards.

The present invention uses a rating system that is based on a matrix of factors with weighting means and documentation and guidelines. In an embodiment of the present invention the matrix of factors incorporates factors/requirements include in the High Objective Uniform State Standard for Educators (HOUSSE) and provides objective rating and documentation of the same. The HOUSSE factors/standards include core content knowledge in academic subject, grade-appropriate knowledge of subject matter, grade-appropriate academic subject matter teaching skills, differentiation of content instruction for diverse learners, and student assessment and achievement of core content concepts.

1. Core Content Knowledge in Academic Subject

Generally, the teachers, participants or users need to posses a core content knowledge in the academic subject which the teacher teaches. For example, in elementary grades, the teacher needs to know reading, writing, math, science, social studies, and the like. In middle school, the teacher needs to have had a minimum number of credit hours in each subject to be taught as determined by the applicable state. Demonstration of this knowledge is the ability to correctly answer content specific questions and demonstrate, describe, or otherwise explain subject matter concepts.

2. Grade-Appropriate Knowledge of Subject Matter

Furthermore, the teacher needs to possess subject matter knowledge at the level in which the teacher teaches. This knowledge is demonstrated within the present invention by the ability to correctly answer grade-appropriate content questions and demonstrate, describe, or explain appropriate grade level subject matter concepts. Appropriate grade level curriculum knowledge includes grade-specific goals and objectives, scope and sequence, pacing, spiraling, and articulation. The teacher should also possess the ability to demonstrate, describe, or explain specific grade-appropriate student activities. Documented experience teaching of subject matter at the level in which the teacher teaches is another indicator of grade-appropriate knowledge of subject matter according to the present invention. By way of example, in a preferred embodiment according to the present invention, the following classifications are used:

Elementary-grade specific knowledge would be in the areas of reading/language arts, mathematics, science, social studies, and others, such as art, music, and physical education.

Reading/Language Arts specific knowledge includes phonics, alphabetic principles, word recognition, sense of story, literary language, literature, decoding, punctuation, comprehension of narrative and expository text, grammar and language conventions, oral and written language skills, composition, parts of speech, writing process, spelling, listening, speaking, types of text (fiction, on-fiction, poetry, drama, and the like), elements of fiction and non-fiction.

Mathematics specific knowledge includes number concepts (counting, comparing, classifying, ordering, and the like), base-ten numeration (place value, writing forms of numbers), addition and subtraction of whole numbers, multiplication and division, concepts related to number theory (factors, multiples, odd and even), rational numbers, problem-solving, geometric concepts (geometric figures), measurement (length, area, volume, weight, and the like), probability and statistics, patterns and relationships, time and temperature, graphing, algebraic expressions.

Science specific knowledge includes similarities and differences in plants and animals, weather and climate, needs of living organisms, soil, rocks, and minerals, life cycles, sound, physical properties, astronomy, light and heat, electricity and magnetism, interdependence of plants and animals, forms and sources of energy.

Social Studies specific knowledge includes social organizations (neighborhoods and communities), social structures (transportation, industry, technology, and economics), history, geography, and government, world regions. Other specific knowledge areas are included within the scope of the present invention, such as vocational arts, visual and performing arts, computers and information technology, and the like, and combinations thereof.

3. Grade-Appropriate Academic Subject Matter Teaching Skills

The teacher should demonstrate teaching skills that incorporate student learning processes and instructional strategies, and should connect curriculum goals with student experiences.

Student learning processes include higher-order thinking skills, problem solving, critical thinking, and memorization. Instructional strategies include whole-group discussion, cooperative learning, direct instruction, discovery learning, graphic organizers such as concept mapping and webbing, independent study, interdisciplinary instruction, inquiry method, and student centers.

Connecting curriculum goals and student experiences include assessing students' prior knowledge, guided practice, independent practice, modeling, problem solving, and transitions.

4. Differentiation of Content Instruction for Diverse Learners

Specific activities are ones that address areas of exceptionality such as learning styles, multiple intelligences, concrete vs. abstract learners, and cultural differences, including languages. The different content instruction includes extra assistance, tutoring, modified expectations, extension of activity/testing time, modification of assignments, peer help, re-teaching, alternative assignments and assessments.

5. Student Assessment and Achievement of Core Content Concepts

Assessment methods include Closed response (multiple choice, true-false, matching, labeling); Limited response (fill-in-the-blank, short-answer, open-ended); Journals, Portfolios, Essay questions, teacher-student contracts, rubric-based assessments, projects, research papers, written or oral presentations, learning log, concept mapping, venn diagrams, role-playing, experiments, learning centers, observation of performance, one-on-one conferences, student explanations, performance-based assessments.

The documentation of these five standards/factors thus provides objective rating & documentation of the same. An example of a documentation-based matrix for rating teacher qualification according to the present invention is shown in Table 1. Shown is the matrix part of a system and method according to the present invention for rating participants in a documentation-based teacher qualification rating system.

TABLE 1
Factor matrix for documentation-based teacher qualification rating system.

| | | | | | | | | | | 5. Student |
|---|---|---|---|---|---|---|---|---|---|---|
| | | | | | | | | 3. Grade | | Assessment |
| | | | | | | | | Appropriate | 4. | and |
| | | | | | | | 2. Grade | Academic | Differentiation | Achievement |
| | | | | | | | Appropriate | Subject | of Content | of |
| | | 1. Core Content | | | | | Knowledge | Matter | Instruction | Core |
| | | Knowledge | | | | | of Subject | Teaching | for Diverse | Content |
| Documentary | Factors/ | in Academic Subject | | | | | Matter | Skills | Learners | Concepts |
| Evidence | Stand- | (Minimum of 5 points) | | | | | (Minimum | (Minimum | (Minimum of | (Minimum |
| [symbol] | ards [symbol] | Points | LA | M | S | SS | of 5 points) | of 5 points) | 3 points) | of 3 Points) |

Essay
Telephone Screening
Interview
In-Person Interview (2
pts)
Teaching Demonstration
Lesson Plan/Unit Plan
Lesson Plan Book
Classroom Observation
Professional References
Verification of
Experience
Professional
Development
University/College
Transcripts (2 pts)
Coursework equivalent to
an undergraduate minor
(for middle school only in
applicable states)
Graduate Coursework in
Subject Area
Subject Area Licensure
In the Home Country
Other
TOTAL

The weighting means for these documentations is based on points. Under each standard/factor the points are allotted based on the demonstration of an evidence with one point being allotted for each evidence except for the In-person interview, Transcripts and Undergraduate Minor Coursework where two points can be allotted. There is no limit to the total number of points allotted under each standard/factor.

The documentation and guidelines preferably include the following: Essay; Telephone screening interview; In-Person Interview/Interview Summary Sheet; Lesson plan/unit plan/lesson plan book; Classroom Observation; Professional reference forms; Verification of experience; Professional development; University/College transcripts; Coursework equivalent to undergraduate minor; Graduate coursework in the subject area; Subject area licensure in the home country and others, such as experience or a subject area test taken in the home country.

The essays ask teachers to address issues such as lesson planning/teaching methodologies including indicating subject area objectives and concepts taught, classroom management, teaching skills, student evaluation/assessment, and differentiation of teaching. The rating administrator will read all essays for documentation of the standards and awards one point under each applicable standard.

Telephone screening interview includes teacher responses to questions on teaching methodology, instructional skills, and lesson planning.

In-Person Interview/Interview documentation includes the following: professional preparation, classroom management and organization, planning for instruction, instructional delivery, monitoring progress & evaluating academic performance. Two points are awarded under each applicable standard.

Lesson plan/unit plan/lesson plan book includes a lesson the teacher has taught in his/her classroom. It includes the subject matter content of the lesson, objectives, teaching strategies, resources, evaluation techniques and summary. One point is awarded under each applicable standard

Classroom Observation includes an evaluation report of an observed lesson rating the teacher on all aspects of the lesson presentation. One point is awarded under each applicable standard.

Professional reference forms includes an official evaluation of the teacher's knowledge of the core content area and grade appropriate content knowledge. If a teacher is rated “very good” or “excellent”, points are awarded to the applicable standard.

Verification of experience—Experience must be officially documented and demonstrate the teacher's experience in the subject and level being evaluated. If the evaluator has indicated the teacher was fully qualified/certified, one point is awarded under standard one and two.

Professional development must be documented and can include workshops, short courses, in-service courses, symposiums, and the like. Points are awarded to the applicable standard.

For University/College transcripts, the ratings administrator refers to the transcripts provided by the teacher and to course descriptions/syllabi, if available. All points awarded based on evidence from university/college transcripts must be given in the same matrix row. As an example, for middle school teachers, points for standard 1 in the row for “coursework equiv” can be assigned. To an academic minor” , and then assign points for other standards in the university/college transcripts row). Course descriptions are requested, if necessary. Two points are awarded under each standard if the transcripts contain:

Standard 1—course(s) specific to the subject area(s).

Standard 2—content and methodology courses specific to the subject area and level.

Standard 3—methodology courses specific to the subject area and level.

Standard 4—course or courses that address teaching diverse learners.

Standard 5—an education/methodology course or courses on student evaluation and assessment

Coursework equivalent to undergraduate minor (for middle school teachers where applicable). In a preferred embodiment, points are given for standard 1 if the transcripts show a minor in the subject. Other standards should be demonstrated using the University/college transcript matrix row.

Graduate coursework in the subject area. In a preferred embodiment, the transcripts are reviewed and one point is given under the applicable standard. In cases of questions concerning transcripts, a certification specialist is consulted.

Subject area licensure in the home country. Preferably, the license should specify the subject and level. Points for standards 1 and 2 are given.

Other documentation includes subject area test in home country, article, award certificate, and the like.

In a preferred embodiment, experience points are granted at a value of one point per year up to a maximum of 5 years (5 points) Experience must be officially documented and only experience teaching the subject and level being evaluated should be credited.

The present invention also includes an automated system and method, which uses an on-line/network-based system that utilizes self-administered teacher inputs and agency-administered rating to rate and document qualification of teachers.

The system is provided as an automated system for managing participants in the qualification program including a network of computers and/or data processing systems having a memory, a processor, a display and user interface, and software running on the system, wherein the network is constructed and configured for communication therebetween such that at least one user is capable of accessing information about the program from the computers. The data processing system(s) may also preferably include at least one server computer for hosting a database that contains information relating to the program, including but not limited to information associated with each of a multiplicity of participants within the program for teacher qualification documentation.

The automated system and method according to the present invention advantageously provides for the program being self-administered by the participants, including administrative matters, such as tracking and auditing, as well as registration and/or application to the program, and providing feedback or referrals. Preferably, the automated system and method according to the present invention provide for an online or web-based implementation that includes the Internet, however, a networked system that is smaller or provides for increased security or more limited access may also or alternatively be employed.

A method for operating a teacher qualification documentation rating system according to the present invention preferably includes the steps of: providing a rating system based on a matrix of factors with factor weighting; inputting factor documentation; determining the individual factor and total factor points based on the inputted factor documentation; and determining the teacher qualification rating based on the total factor points.

Certain modifications and improvements will occur to those skilled in the art upon a reading of the foregoing description. By way of example, a point-based reward program that awards points to the teacher participants to encourage improved performance and/or participation levels while teaching in the new position is further enhanced by the application of the system and method according to the present invention, i.e., a rating system makes goals and rewards more tangible and therefore improves participation by the users/teachers. Also, computer readable medium including information relating to the system and/or method of the present invention, its administration, and/or instructions for providing the present invention are also considered within the scope of the present invention, in order to provide for distribution and data separate from a computer or computer-type device. A computer readable medium and/or computer executable program code residing on a computer readable medium and/or a computer for providing a teacher rating system as set forth hereinabove including information relating to the program and/or teacher documentation, such as the exchange of documentation and program administration, wherein the program is to be administered and the participants managed over a predetermined period, and/or archived as needed.

All modifications and improvements have been deleted herein for the sake of conciseness and readability but are properly within the scope of the following claims.

1. A system for rating teacher qualification comprising:
a rating system based on a matrix of factors with factor weighting;
matrix factor documentation inputted into the rating system;
and teacher experience documentation inputted into the rating system;
wherein the inputted matrix factor documentation and inputted teacher experience documentation are weighted and used to produce a qualification score.

2. The system of claim 1, wherein the matrix factor documentation is selected from the group consisting of objective documentation, subjective documentation, and combinations thereof.

3. The system of claim 2, wherein the matrix of factors is selected from the group consisting of a) core content knowledge in academic subject, b) grade-appropriate knowledge of subject matter, c) grade-appropriate academic subject matter teaching skills, d) differentiation of content instruction for diverse learners, e) student assessment and achievement of core content concepts; and combinations thereof.

4. The system of claim 3, wherein the matrix of factors includes HOUSSE requirements.

5. The system of claim 1, wherein the documentation weighting includes assigning points from a points scale based on predetermined scale criteria.

6. The system of claim 1, wherein the teacher experience documentation is selected from the group consisting of education-related documents, work-history-related documents, and combinations thereof.

7. The system of claim 6, wherein the documentation includes diplomas, certificates, transcripts, thesis, licensure, professional reference forms/letters, verification of experience, and professional development.

8. A method for teacher qualification documentation rating, the method steps comprising:
providing a rating system based on a matrix of factors with factor weighting;
inputting factor documentation;
determining the individual factor and total factor points based on the inputted factor documentation;
determining the teacher qualification rating based on the total factor points.

9. The method of claim 8, further comprising a step of at least one teacher participant inputting at least part of the documentation for self-administration of the system by the participants.

10. The method of claim 8, further comprising a step of a rating agency administering the rating.

11. A computer readable medium and/or computer executable program code residing on a computer readable medium and/or a computer for providing a documentation-based teacher qualification rating system comprising:
information relating to the program, including:
a rating system based on a matrix of factors with factor weighting means;
matrix factor documentation; and
teacher experience documentation;
wherein the teacher experience documentation and matrix factor documentation are
weighted and used to produce a qualification score.

12. The system of claim 11, wherein at least part of the documentation is inputted by at least one teacher participant.

13. The system of claim 11, wherein the rating is administered by a rating agency.

14. A computer readable medium and/or computer executable program code residing on a computer readable medium and/or a computer for providing a documentation-based teacher qualification rating method, the method steps comprising:
providing a rating system based on a matrix of factors with factor weighting;
inputting factor documentation;
determining the individual factor and total factor points based on the inputted factor documentation;
determining the teacher qualification rating based on the total factor points.

15. The method of claim 14, wherein at least part of the documentation is inputted by at least one teacher participant.

16. The method of claim 14, wherein the rating is administered by a rating agency.
